(19) United States
(12) Patent Application Publication
(10) Pub. No.: US 2023/0062879 A1
(43) Pub. Date: Mar. 2, 2023

(54) Instrument For Visceral Manipulation And Related Methods

(71) Applicant: David Kulla, New York, NY (US)

(72) Inventor: David Kulla, New York, NY (US)

(21) Appl. No.: 17/821,603

(22) Filed: Aug. 23, 2022

Related U.S. Application Data
(60) Provisional application No. 63/236,742, filed on Aug. 25, 2021.

(51) Int. Cl. A61H 21/00

(52) U.S. Cl. CPC A61H 21/00

(57) ABSTRACT

An instrument for visceral manipulation of tissue comprising a shaft having a first end and a second end and a pressure applicator tip coupled to the first end of the shaft. The pressure application tip has a front surface, a back surface, and an edge. The instrument also includes a handle coupled to the second end of the shaft. The front surface of pressure applicator tip has a curved profile. The front surface and the edge are configured to apply pressure to a skin portion. A method for visceral manipulation of an organ is also disclosed.

### CROSS REFERENCE TO RELATED APPLICATION

This application claims the benefit of priority to U.S. Provisional Patent Application Ser. No. 63/236,742, filed Aug. 25, 2021 (pending), the disclosure of which is incorporated by reference herein in its entirety.

### TECHNICAL FIELD

The invention relates generally to instruments for visceral manipulation, especially instruments for visceral manipulation of a hiatal hernia.

### BACKGROUND

A hiatal hernia occurs when the upper part of a patient's stomach bulges through the large muscle, namely, the diaphragm, separating the abdomen and chest. The diaphragm has a small opening, namely, the hiatus, through which the food tube, namely, the esophagus, passes before connecting to the stomach. When a hiatal hernia occurs, the upper part of the stomach pushes up through the diaphragm and into the chest. More specifically, the upper part of the stomach pushes up through the hiatus (a small opening in the diaphragm) through which the esophagus passes before connecting to the stomach.

Typically, a hiatal hernia does not cause problems for a patient, and in fact, the patient may not be aware of the condition unless a physician checks for it or if the patient is symptomatic, which is approximately 15% of hiatal hernia cases. A large hiatal hernia, however, may allow food (dysphagia) and acid to back up into the esophagus, leading to acid reflux or gastroesophageal reflux disease (GERD). To mitigate these symptoms, a physician may proscribe Proton pump inhibitors. For many patients, however, Proton pump inhibitors do not ward off acid reflux or GERD and sometimes may even make the condition worse. In addition, there are adverse side effects with the long-term use of Proton pump inhibitors. A hiatal hernia may be effectively corrected with laparoscopic surgery. Such a surgical repair may be effective for up to seven years with a high failure rate. Most patients with hiatal hernia want to avoid surgery, but if they have surgery they often see their symptoms return within seven years.

There are many instruments for instrument-assisted soft tissue mobilization (IASTM), including IASTM instruments for myofascial release like Graston and rockblades. As the name suggests, these IASTM instruments are intended only for soft tissue mobilization and are not meant for visceral manipulation (the manipulation of organs).

What is needed, therefore, are instruments that may be used for visceral manipulation of organs.

### SUMMARY OF THE INVENTION

To these and other ends, an instrument for visceral manipulation includes a shaft having a first end and a second end; a pressure applicator tip coupled to the first end of the shaft, the pressure application tip having a front surface, a back surface and an edge; and a handle coupled to the second end of the shaft. The front surface of the pressure applicator tip has a curved profile. The front surface and the edge are configured to apply pressure to a skin portion. The handle may be a generally spherical knob. The shaft may include a straight section and a curved section. The pressure applicator tip may be coupled to the curved section of the shaft and the handle may be coupled to the straight section of the shaft.

In one aspect, the front surface has a height and a width and the curved profile is curved along the height of the front surface. In another aspect, the front surface has a height and a width and the curved profile is curved along the width of the front surface. In yet another aspect, the front surface has a height and a width and the curved profile is curved along both the height of the front surface and the width of the front surface.

In one aspect, the shaft, the pressure applicator tip, and the handle may form a unitary structure. In addition, the shaft, the pressure applicator tip, and the handle may each be made of the same material.

In one aspect, the back surface of the pressure applicator tip may be oriented to approximately 45 degrees to the straight section of the shaft.

The invention also contemplates a method for viscerally manipulating an organ of a patient. The method includes (a) providing an instrument comprising: a shaft having a first end and a second end, a pressure applicator tip coupled to the first end of the shaft, the pressure application tip having a front surface, a back surface, and an edge, and a handle coupled to the second end of the shaft. The method further includes (b) orienting the instrument so that a longitudinal axis of the instrument is at an angle to the horizontal and the shaft tilts towards the feet of the patient; (c) contacting the edge of the pressure applicator tip on a skin portion overlying an organ, the front face facing towards the head of the patient; (d) while applying pressure to the skin portion with the edge of the pressure applicator tip, moving the edge of the pressure applicator tip along the skin portion in a direction towards the chest of the patient; (e) rotating the handle towards the head of the patient such that the front face of the pressure applicator tip contacts that skin portion; and (f) while applying pressure to the skin portion with the front face of the pressure applicator tip, moving the front face of the pressure applicator tip in a direction towards the feet of the patient. The organ may be a stomach, for example.

In one aspect, in step (b) the angle of the longitudinal axis to the horizonal may be approximately 45 degrees. In that regard, the back face of the pressure applicator tip is approximately perpendicular to the horizontal.

The method may also include repeating steps (b)-(f) at least once. In one aspect, the method may further include applying a lubricant to the skin portion. The method may further include placing the patient's back on a support surface.

In one aspect, the moving of the front face of the pressure applicator tip in the direction towards the feet of the patient terminates proximal a belly button of the patient.

### BRIEF DESCRIPTION OF THE DRAWINGS

The accompanying drawings, which are incorporated in and constitute a part of this specification, illustrate one or more embodiments of the invention and, together with a general description of the invention given above, and the detailed description given below, serve to explain the invention.

FIG. 1 is a perspective view of an instrument according to an embodiment of the invention.

FIG. 2 is another perspective view of the instrument of FIG. 1.

FIG. 3A is a partial cross-sectional view of the instrument of FIG. 1.

FIG. 3B is a partial plan view of the instrument of FIG. 1.

FIG. 4A is schematic representation of a patient using the instrument of FIG. 1 to implement one step of a treatment procedure for a hiatal hernia.

FIG. 4B is schematic representation of a patient using the instrument of FIG. 1 to implement another step of a treatment procedure for a hiatal hernia.

FIG. 4C is schematic representation of a patient using the instrument of FIG. 1 to implement yet another step of a treatment procedure for a hiatal hernia.

FIG. 5A is schematic representation illustrating the instrument of FIG. 1 implementing one step of a treatment procedure for a hiatal hernia.

FIG. 5B is schematic representation illustrating the instrument of FIG. 1 implementing another step of a treatment procedure for a hiatal hernia.

FIG. 5C is schematic representation illustrating the instrument of FIG. 1 implementing yet another step of a treatment procedure for a hiatal hernia.

### DETAILED DESCRIPTION OF THE INVENTION

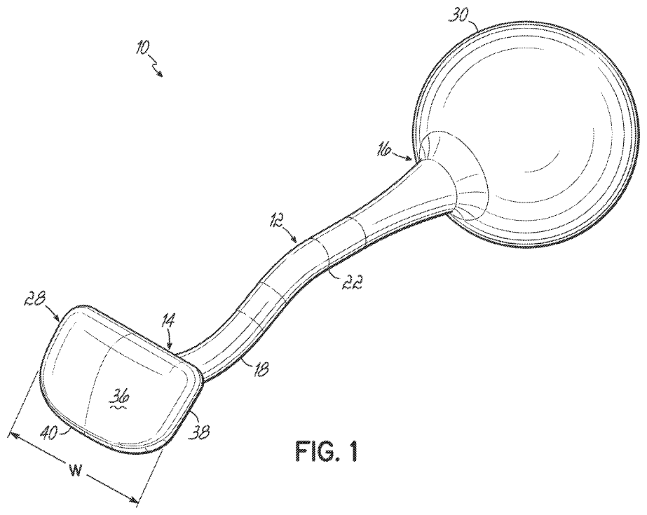

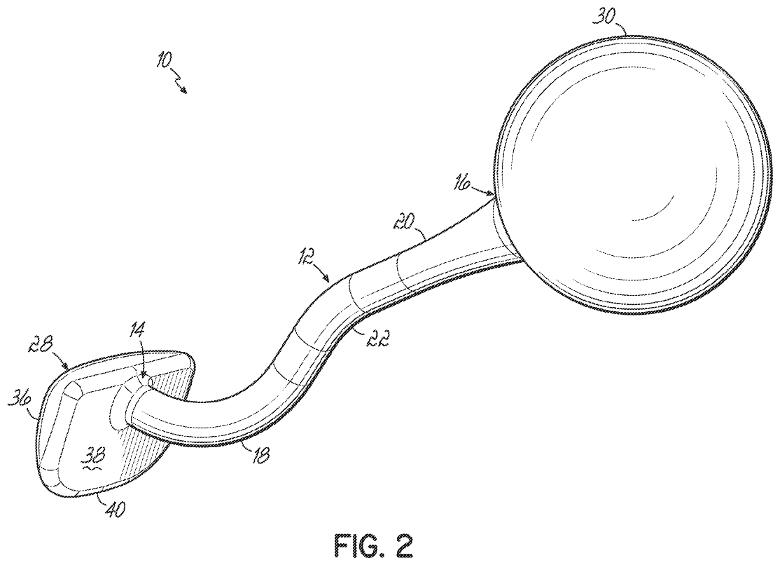

The invention is a device/instrument for instrument-assisted visceral manipulation (IAVM). To that end, an instrument 10 for treating a hiatal hernia according to one embodiment of the invention as illustrated in FIGS. 1-3B. The instrument 10 includes a shaft 12 with first and second opposing ends 14, 16. In an embodiment the shaft 12 may include a curved or arcuate section 18 and a generally straight section 20 joined at an intermediate position 22, where the first end 14 is at one end of the curved section 18 spaced from the intermediate position 22 and the second end 16 is at one end of the straight section 20 spaced from the intermediate position 22. The instrument 10 further includes a pressure applicator tip 28 that is connected to the first end 14 of the shaft 12. The instrument 10 also includes a handle 30 that is connected to the second end 16 of the shaft 12. The handle 30 is configured to be gripped by a hand. While the handle 30 is illustrated as being a generally spherical knob, it will be appreciated that the handle 30 may be formed of any appropriate shape that is suited for being gripped by a hand.

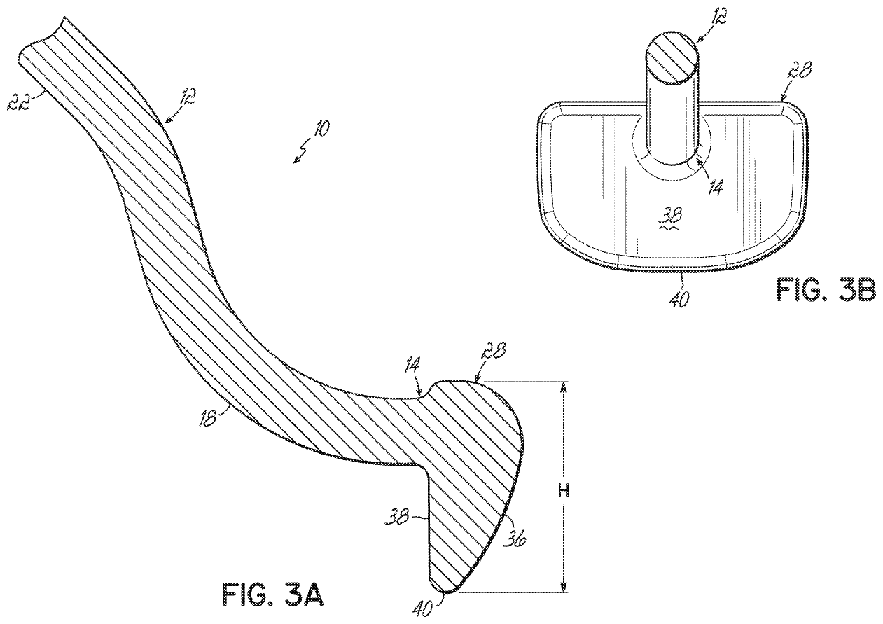

The pressure applicator tip 28 includes a front surface 36 and a back surface 38 and an edge 40. In an embodiment, the front surface 36 may have a compound, curved profile and the back surface may be generally planar as illustrated in FIGS. 1, 2, and 3A. As used herein, the term compound means that the front surface 36 is curved along both a height H of the front surface 36 as illustrated in FIG. 3A and a width W of the of the front surface 36 as illustrated in FIG. 1. In other embodiments, the front surface 36 may have a curved profile only along the height H of the front surface 36 or only along the width W of the front surface 36. In some aspect of its use, the front surface 36 contacts and applies pressure to the skin or a skin portion of a patient being treated. The compound, curved profile of the front surface 36 may allow the pressure to be applied evenly over a wider area of the skin portion so the contacted skin portion may not experience a peak in pressure at any given point. Thus, the compound, curved profile of the front surface 36 may provide a more comfortable patient experience.

In an embodiment, the instrument 10 may be a monolithic or unitary structure and all the components, e.g., the shaft 12, the pressure applicator tip 28, and the handle 30, are made from the same material. To that end, the instrument 10 may be made from any suitable material such as metal (e.g., stainless steel), plastic, wood, or polymers. In another embodiment, the instrument 10 made be formed by connecting separate components together. For example, the shaft 12, the pressure applicator tip 28, and the handle 30, may be formed individually and then secured to each other via adhesive, fasteners, welding, etc. in order to form the instrument 10.

Where the instrument 10 is made from separate components, each component may be made of a different material. For example, the shaft 12 may be formed of plastic, the pressure applicator tip 28 may be formed of stainless steel, and the handle 30 may be formed on wood.

In an embodiment, the instrument 10 may have an overall length in the range of between approximately 4 inches to approximately 10 inches, more preferably between approximately 5 inches to approximately 9 inches, and most preferably between approximately 6 inches to approximately 8 inches. The shaft 12 may have a diameter in the range of approximately ¼ of an inch to approximately ½ of an inch, and more preferably approximately 5/16 of an inch. The dimensions identified herein are not intended to be limiting as the different components may have a range of suitable dimensions. In an embodiment, the pressure applicator tip 28 may be oriented on the first end 14 of the shaft 12 such that the back surface 38 is approximately perpendicular to the horizontal when the longitudinal axis of the shaft 12 is approximately 45 degrees to the horizontal as schematically depicted in FIG. 3A.

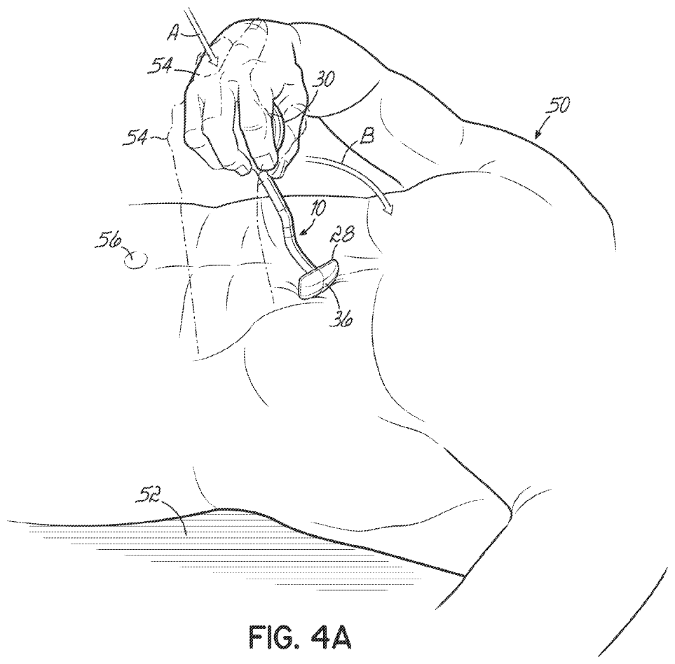

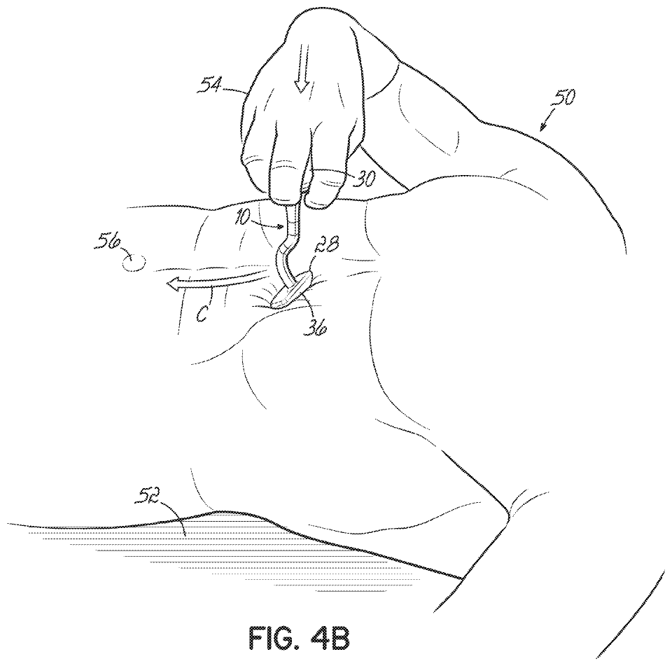

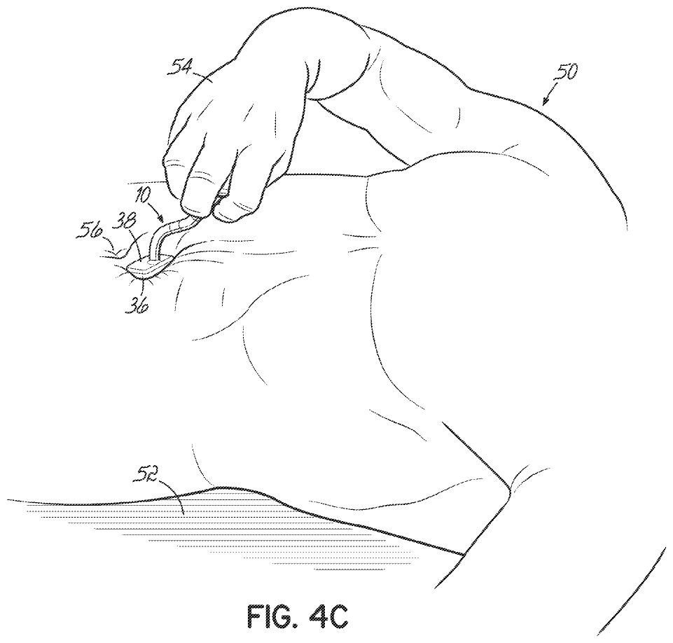

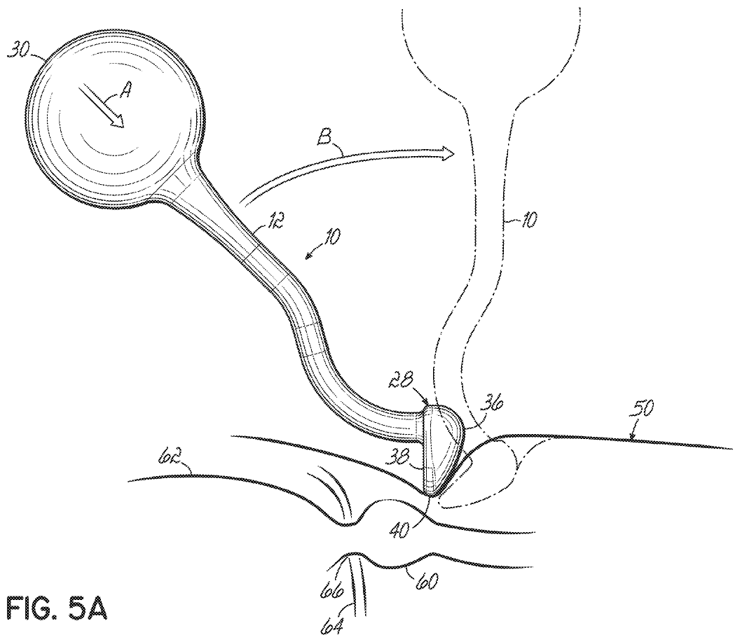

The invention further contemplates a method for using the instrument 10 to treat a hiatal hernia, for example. The method will be described herein as if the patient is self-administering the treatment method to their own body using instrument 10. Alternatively, a health care provider may use the instrument 10 to administer the treatment method on the patient. With reference to FIG. 4A, the first step of the method is positioning and preparing a patient 50. To that end, the patient 50 may lie down on his/her back on a comfortable support surface 52, such as a yoga mat, carpeted floor, or bed, for example. The patient 50 may place one or more pillows under his/her knees. If lying flat on his/her back is too painful for the patient 50, the patient 50 may also place one or more pillows under his/her mid to upper back as well. The patient 50 may apply lotion, petroleum jelly, or other suitable lubricant slightly to the skin portion overlying the tissue to be treated, such as left of the Xiphoid process (the cartilaginous section at the lower end of the sternum), and approximately two inches down the bottom of the left rib to cover the area to be contacted by instrument 10.

The second step of the method employs the instrument 10. To that end and with reference to FIG. 4A, a patient 50 grasps the handle 30 with one or both hands 54 and orients the instrument 10 so that the curved section 18 is pointing downwardly and a longitudinal axis of the instrument 10 is approximately 45 degrees relative to the support surface 52 such that the shaft 12 leans toward the feet. In this orientation and as noted above, the back surface 38 of the pressure applicator tip 28 may be approximately perpendicular to the support surface 52. With the instrument 10 properly oriented, the patient 50 places the edge 40 of the pressure applicator tip 28 on the skin about ¼ of an inch to about ½ of an inch to the left of the Xiphoid process and slightly below the rib proximate the Xiphoid process. The patient 50 then pushes the edge 40 of the pressure applicator tip 28 into the skin portion as indicated by Arrow A and guides the edge 40 of the pressure applicator tip 28 upwardly towards the rib cage. In an embodiment, the patient 50 may push the edge 40 of the pressure applicator tip 28 at least partially underneath the rib cage. While the patient 50 pushes the edge 40 of the pressure applicator tip 28 into the skin and/or moves/glides the edge 40 of the pressure applicator tip 28 along the skin portion, the patient 50 should breath in and out, relax his/her abdominal muscles with each exhalation, and sink into the support surface 52 (i.e., mat, bed, floor).

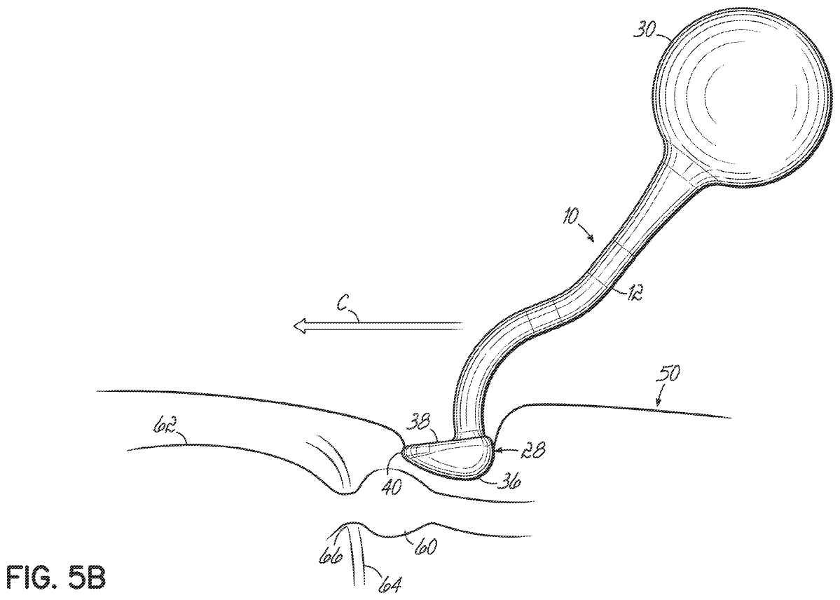

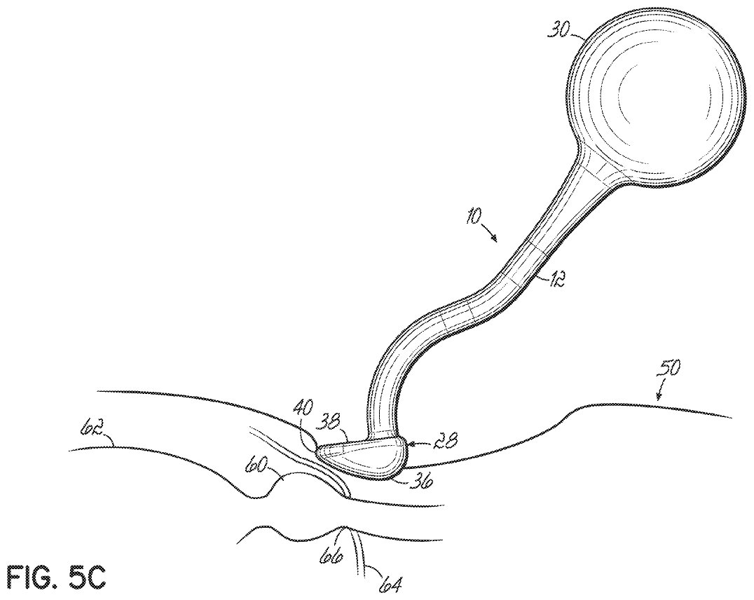

The patient 50 may relax the stomach more and more while he/she continues to slowly add pressure to a tolerable level via the pressure applicator tip 28. The pressure will typically cause soreness for the patient 50, but the soreness should improve over time with repeated treatments. As the patient 50 applies pressure to the skin portion grasping the handle 30 with both hands, it is beneficial to maintain constant pressure on the skin portion. The third step of the method begins when the patient 50 starts to feel a pulsation under the pressure applicator tip 28. The patient 50 may gradually rotate the handle 30 toward his/her head as indicated by Arrow B (FIGS. 4A and 5A) such that approximately all of the front surface 36 of the pressure applicator tip 28 contacts the skin portion as illustrated in FIGS. 4A and 5A. In other words, the pressure to the skin portion will transition from the edge 40 to the front surface 36. With the instrument re-oriented, the patient 50 may begin moving/gliding the pressure applicator tip 28 (while applying constant pressure) in a direction towards the belly button 56, ending in the position shown in FIG. 4C. In an embodiment, the patient 50 may apply approximately 10-20 lbs. of force. When the patient 50 has tight abdominal muscles, resistance, or extra belly fat, the patient 50 may need to apply approximately 20-30 lbs. of force.

Once the pressure applicator tip 28 reaches the belly button 56, the patient 50 may stop and repeat the second and third steps. For first time users of the instrument 10, the second and third steps may be repeated three times, once a day, for the first three days. If the patient 50 is sore, then the patient 50 may take a day off in between treatments. After three treatments, the patient 50 may perform the second and third steps five times every other day. When the patient's symptoms have improved 50%, the patient 50 may start one or more of the following daily exercises: 1. weighted breathing; 2. side expansion breathing; 3. diaphragmatic breathing retraining with alternate leg extension; 4. breathe in hold; 5. recruitment transversus abdominis; 6. mid-back extension; 7. pectoralis minor stretch; 8. pectoralis stretch (90 degree); 9. wall angel; and 10. abs and hip flexors release.

As noted above, when a hiatal hernia occurs, the stomach pushes up through the hiatus in the diaphragm and into the chest. The goal of the method described above is to move the portion of the stomach above the diaphragm back into the abdomen below the diaphragm. This movement of the stomach is known visceral manipulation. FIG. 5A shows a portion 60 of a stomach 62 on the chest-cavity side of a diaphragm 64. The instrument 10 is being pushed towards the rib cage and then rotated up as indicated by Arrow B. In FIG. 5B, the instrument 10 pushes down on the skin portion as it moves towards the belly button 56 as indicated by Arrow C. That motion assists moving the portion 60 of the stomach 62 back through a hiatus 66 in the diaphragm 64. FIG. 5C shows that the portion 60 has passed through the hiatus 66 and is now back on the abdomen side of the diaphragm 64. FIG. 5C represents successful visceral manipulation of the portion 60 of the stomach 62.

While the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An instrument for visceral manipulation comprising:
a shaft having a first end and a second end,
a pressure applicator tip coupled to the first end of the shaft, the pressure application tip having a front surface, a back surface and an edge; and
a handle coupled to the second end of the shaft;
wherein the front surface of the pressure applicator tip has a curved profile, and
wherein the front surface and the edge are configured to apply pressure to a skin portion.

2. The instrument of claim 1, wherein the front surface has a height and a width, and wherein the curved profile is curved along the height of the front surface.

3. The instrument of claim 1, wherein the front surface has a height and a width, and wherein the curved profile is curved along the width of the front surface.

4. The instrument of claim 2, wherein the front surface has a height and a width, and wherein the curved profile is curved along both the height of the front surface and the width of the front surface.

5. The instrument of claim 1, wherein the handle is a generally spherical knob.

6. The instrument of claim 1, wherein the shaft, the pressure applicator tip, and the handle form a unitary structure.

7. The instrument of claim 6, wherein the shaft, the pressure applicator tip, and the handle are each made of the same material.

8. The instrument of claim 1, wherein the shaft includes straight section and a curved section.

9. The instrument of claim 8, wherein the pressure applicator tip is coupled to the curved section of the shaft and the handle is coupled to the straight section of the shaft.

10. The instrument of claim 8, wherein the back surface of the pressure applicator tip is oriented to approximately 45 degrees to the straight section of the shaft.

11. A method for viscerally manipulating an organ of a patient comprising:
(a) providing an instrument comprising:
a shaft having a first end and a second end,
a pressure applicator tip coupled to the first end of the shaft, the pressure application tip having a front surface, a back surface, and an edge; and
a handle coupled to the second end of the shaft;
(b) orienting the instrument so that a longitudinal axis of the instrument is at an angle to the horizontal and the shaft tilts towards the feet of the patient;
(c) contacting the edge of the pressure applicator tip on a skin portion overlying an organ, the front face facing towards the head of the patient;
(d) while applying pressure to the skin portion with the edge of the pressure applicator tip, moving the edge of the pressure applicator tip along the skin portion in a direction towards the chest of the patient;
(e) rotating the handle towards the head of the patient such that the front face of the pressure applicator tip contacts that skin portion; and
(f) while applying pressure to the skin portion with the front face of the pressure applicator tip, moving the front face of the pressure applicator tip in a direction towards the feet of the patient.

12. The method of claim 11, wherein in step (b) the angle of the longitudinal axis to the horizonal is approximately 45 degrees.

13. The method of claim 12, wherein in step (b) the back face of the pressure applicator tip is approximately perpendicular to the horizontal.

14. The method claim 11, further comprising, repeating steps (b)-(f) at least once.

15. The method claim 11, wherein the organ is a stomach.

16. The method of claim 11, further comprising:
prior to step (c), applying a lubricant to the skin portion.

17. The method of claim 11, further comprising:
prior to step (b), placing the patient's back on a support surface.

18. The method of claim 11, wherein in step (f), the moving of the front face of the pressure applicator tip in the direction towards the feet of the patient terminates proximal a belly button of the patient.
